(19) United States
(12) Patent Application Publication
(10) Pub. No.: US 2005/0233741 A1
(43) Pub. Date: Oct. 20, 2005

(54) System for setting up a connection between two users of a telecommunication network

(76) Inventors: Moussavi Mojdeh Zamani, Paris (FR); Julien Kahn, Paris (FR); Christian Licoppe, Paris (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/509,504

(22) PCT Filed: Mar. 7, 2003
(86) PCT No.: PCT/FR03/00747

§ 371 Date: May 31, 2005

(30) Foreign Application Priority Data
Mar. 29, 2002 (FR) 0204028

(51) Int. Cl. H04Q 7/20

(52) U.S. Cl. 455/432.3

(57) ABSTRACT

A System for setting up communications between users of a telecommunication network (1, 10), comprising a central server (2), this server comprising: means (4) for receiving and memorizing user identifiers, associated with information necessary to set up a communication with the user's terminal and profile information based on which the user would like to get into anonymous communication with other service users; means for distributing the received profile information on user terminals (5, 8), and means for receiving requests from user terminals for setting up a communication based on user profile information, and means for setting up on request a communication between two user terminals; each user terminal comprising means for receiving and displaying user profile information sent by the central server, means for selecting the profile information of a user, and means for transmitting to the central server a request to set up a communication with the user corresponding to the selected profile information.

This invention relates to setting up a communication between two users of telecommunication networks such as radiotelephony networks.

At the present time, two users connected to a telecommunication network may be put in communication through this network only if one of the two users dials the other user's telephone number on his communication terminal, which he cannot do unless he knows this telephone number.

There are directory information services accessible through a telecommunication network to obtain the telephone number of a required correspondent, and to get into communication with this correspondent. However, this service cannot be used unless the identity and/or physical address of the required correspondent are known.

However there is a need for anonymous communication. Thus, on the Internet network, there are “chat” services to which users can register using a pseudonym and that they use to dialog between each other using the keyboard of their terminal anonymously, and all that can be seen when a user expresses himself is his pseudonym.

At the present time, there is no such service in telephony networks.

The purpose of this invention is to eliminate this disadvantage. This objective is achieved by providing a system for setting up communications between users of a telecommunication network, each user being provided with a terminal providing access to the telecommunication network.

According to the invention, this system comprises a central server designed to provide a service for setting up a communication, this server comprising:
means for memorizing a user identifier for the communication set up service, for each user, associated with information necessary to set up a communication with the user's terminal, and profile information based on which the user would like to use his terminal to get into anonymous communication with other service users;
means for receiving profile information sent by users, and storing them in the memory means;
means for distributing the received profile information on user terminals, and
means for receiving requests from user terminals for setting up a communication based on user profile information, and means for setting up a communication between two user terminals following reception of a communication set up request,
   each user terminal comprising means for receiving and displaying user profile information sent by the central server, means for selecting profile information of a user, and means for transmitting to the central server a request to set up a communication with the user corresponding to the selected profile information.

Advantageously, the user terminals are fixed or mobile terminals.

According to one specific feature of the invention, the central server comprises means for extracting a list of user profiles corresponding to a selection criterion sent by a user terminal, from the memory means, and means for transmitting the extracted list to the user terminal.

According to another specific feature of the invention, the central server comprises means for determining a geographic position of users registered in the communication set up service, means for inserting the geographic position of each user in the memory means in association with profile information, and means for extracting from the memory means a list of user identifiers located close to a determined user, using memorized geographic positions.

According to yet another specific feature of the invention, at least some of the terminals of users of the communication set up service are of the mobile terminal type including low range communication means so as to communicate directly with other nearby user terminals without needing a telecommunication network, the central server comprising means for transmitting information necessary for setting up a direct communication with the terminal located nearby, to a mobile terminal following reception of a request sent by the terminal to set up a communication with the nearby terminal.

Preferably, the central server uses a WAP and/or Web service.

According to another specific feature of the invention, the user profile information contains exchange proposals, each exchange proposal including types and quantities of exchangeable data offered and requested in exchange, the central server further comprising means for receiving exchange validation messages sent by terminals of users who accepted an exchange proposal sent by a user, and means for retransmitting each received validation message to the terminal of the user who sent the corresponding exchange proposal, and means for updating exchangeable user data accounts whenever a proposal for an exchange is accepted, as a function of types and quantities of data to be exchanged specified by the accepted exchange proposal.

According to yet another specific feature of the invention, each user terminal in the exchange service includes means for transmitting a message to the central server to request the quantity of data appearing on each account available to the user, and means for receiving and displaying the data type and quantity information received in response from the central server.

According to yet another specific feature of the invention, the central server comprises means for canceling an exchange transaction validated when exchanged data are not shown on the corresponding accounts of users participating in the transaction.

The invention also relates to a terminal used to equip users of a communication set up service.

According to the invention, this terminal comprises:
connection means for connecting the terminal to a central server through a telecommunication network,
means for inputting and sending to the central server profile information including a user identifier,
means for receiving from the central server lists of profile information sent by other users of the communication set up service, means for displaying these lists on the terminal, and means for selecting a displayed user profile, and
means for sending a request to set up a communication with the user corresponding to the user profile displayed by the terminal and selected by selection means.

Advantageously, this terminal is of the fixed or mobile terminal type.

According to one specific feature of the invention, this terminal is of the mobile terminal type and includes low range communication means used to communicate directly with other nearby user terminals, and means for receiving information necessary to set up a direct communication with the nearby terminal, when requested.

According to one specific feature of the invention, the terminal further comprises:
means for inputting an exchange proposal including an identifier of the user sending the exchange proposal, a type and a quantity of exchangeable data offered, and a type of data requested in exchange, and sending this proposal to the central server,
means for receiving and displaying lists of exchange proposals sent by the other users of the exchange service, the lists being transmitted through the central server, and means for selecting a displayed exchange proposal, and
means for sending a validation order for an exchange proposal displayed by the terminal and selected by said validation means.

According to yet another specific feature of the invention, the terminal includes means for displaying a download window in which icons are displayed symbolizing exchanged data, to give the user the impression of physically exchanging data.

One preferred embodiment of the invention will be described below as a non-limitative example, with reference to the appended drawings, wherein:

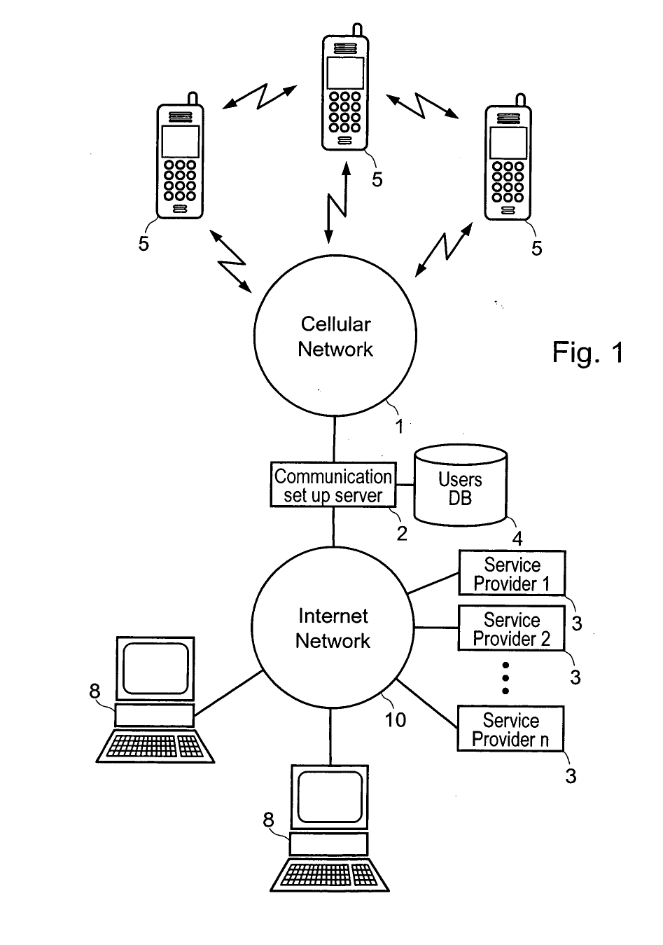

FIG. 1 shows a system for setting up a communication according to the invention;

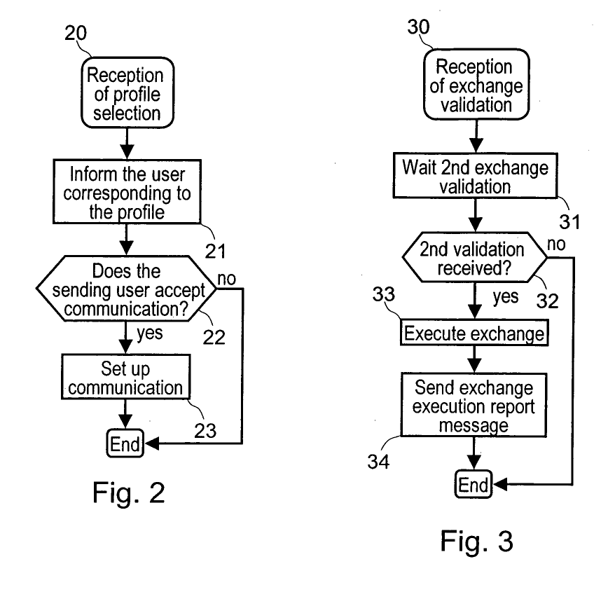

FIGS. 2 and 3 illustrate steps performed by the central server according to the invention in the form of flowcharts.

In FIG. 1, the system for setting up a communication according to the invention includes a central server 2 that communicates with a plurality of fixed terminals 8 or mobile terminals 5 of users, through telecommunication or data transmission networks 1, 10 such as the Internet network or a radiotelephony network, for example of the GSM or UMTS type. The mobile terminals 5 may be for example mobile telephones or other mobile devices, and fixed terminals 8 may be for example computers or personal assistants.

For example, the central server 2 offers a service conforming to the Wireless Application Protocol (WAP) to users who access the service using a mobile terminal 5. For users with a terminal connected to the Internet network 10, the service to set up a communication may be in the form of a Web site.

To benefit from the communication set up service, users must be registered with the central server 2, for example by supplying an identifier of their choice, the central server 2 sending an access and recognition password in response that the user must input into his terminal 5, 8 so that he can be recognized during each connection to the service. The user must also provide the central service with an identifier of his terminal recognized on the network to which he is connected (for example a telephone number or an instantaneous message service identifier) that the central server will use to transmit information or set up a communication with the user's terminal.

Therefore, the central server 2 memorizes a list of registered users in a database 4, in which an identifier and a corresponding password are stored for each user, together with the identifier of the user's terminal recognized on the network to which he is connected.

Users also need to supply the central server with profile information based on which they want to be put into communication with other users. The user can modify this information at any time, and it is also stored in the database 4 in association with the user's identifier.

For example, this information may include:
the physical and/or psychological profile of the user,
subjects or themes in which the user is interested,
a profile of persons with which the user would like to be put into communication,
descriptions of commercial objects or advantages that the user would like to purchase, sell or exchange,
etc.

A user can advantageously be registered with the communication set up service from a personal computer 8 connected to the Internet network 10, the central server providing a Web registration service for the service in which it sends on-line registration forms, and in return receives information supplied in these forms.

Information between the central server and the mobile terminals 5 of users may for example be transmitted through SMS (Short Message Service) or MMS (Multimedia Message Service) type messages, or in data downloading mode.

To access the communication set up service, users must also install a dedicated application program in their terminal 5,8, for example by downloading it from the server 2. This program is designed to provide an ergonomic man/machine interface facilitating the input of user commands and simplifying display of the contents of messages exchanged with the central server or other user terminals of the communication set up service.

In particular, this application program installed in each terminal enables the user to:
send requests dealing with user profiles stored in the database 4,
receive profile lists sent by other users of the service and stored in the database 4, from the central server and,
select a profile located in a profiles list displayed by the terminal, particularly in order to select a correspondent with which the user would like to get into communication.

This application program may also be designed to input and modify user profile data in the database 4, through the central server 2.

When a registered user would like to access the communication set up service, he must connect to the WAP or Web service on the central server 2 using a particular function of the application program. Once connected to the service, he can use the application program to input requests to extract profile lists applied to the database 4.

Profile data are advantageously sorted by type or category so that the user can easily specify a selection request applied to the database 4, for example through selection menus.

Moreover, the central server 2 comprises means for executing requests for extraction of user profile lists from the database 4, sent by users, and for transmitting result lists to these users. These result lists are transmitted either in data transmission mode when the list addressee is connected to the service, or in the form of a short message.

These requests may apply to all profiles sent by service users stored in the database 4, or only the most recent profiles sent (starting from a date specified by the user), or they may apply to users nearby the user who sent the request in the case in which the central server can access geographic positioning functions of users of a mobile telephone network.

When a user is interested in a profile appearing in a list displayed on his terminal 5, 8, he can select it, and this triggers the user's terminal sending the selected profile reference to the central server 2. On reception of such a message, the server 2 executes the procedure 20 represented in FIG. 2. In this Figure, the central server that receives a profile reference informs the user who sent the profile that another user would like to get into direct communication with him, in step 21. If the user thus contacted accepts the communication (step 22), the central server sets up the communication between the two users (step 23).

For example, this type of communication may be made through an instantaneous message service. If the terminals of the two users are of the telephone type, this communication may also be verbal, preferably at the choice of the users.

According to one variant of the system according to the invention, the central server 2 has access to geographic positioning functions that may for example be offered through the network 1, so as to locate the positions of users registered with the communication set up service and using a mobile terminal, each terminal being identifiable through information supplied at the time that the user is registered. Based on this positioning information provided by the network, the server 2 inputs the received positioning information into the database 4, namely the geographic position of each user, corresponding to the user's identifier.

The application program installed on each terminal can also be used to limit profile lists transmitted by the communication set up service in response to requests, to include only the profile lists sent by users located nearby. Similarly, the central server includes means for determining which users are located nearby a determined user, based on geographic positioning information of users of the service, and means for building up and sending a list of profiles sent by other users located nearby the user who sent the request, when requested.

According to another variant of the system according to the invention, user terminals are provided with low range communication means, for example conforming to the “Bluetooth” standard or the “802.11” standard or “WiFi” standard. A network accessible through this type of communication means is firstly capable of physically locating user terminals but also informing each user of the communication set up service about the nearby presence of other service users. For example, this type of warning may be sent by the server 2 by sending an SMS type message. On reception of such a message, each user can use an application program to choose whether or not to be “visible” to other nearby users. If they choose to be visible, they must input their choice in the terminal, and this triggers the user's terminal sending a message to the server 2. In response, the server sends the list of profiles provided by all users of “visible” terminals located nearby. The application program installed in the terminal then displays the received list.

When a user selects a profile sent by another located nearby user from the list displayed on his terminal, the terminal of the first user will use the low range communication means to get into direct communication with the second user's terminal using addressing information provided by the central server. The communication thus set up is made without the central server.

With the system described above, users can get into contact with other users by affinity, while guaranteeing that they all remain anonymous.

The system that has just been described is applicable particularly to exchange of data such as reduction or purchase vouchers, loyalty points at a particular shop, free kilometers on the purchase of a transport ticket, or free communication minutes through a fixed telephone or a mobile provided by a telephone network operator.

Data exchanged may also consist of rights to reproduce music or films, or software licenses.

In this case, the system may also be designed to manage exchange transactions between users, to give them a certain degree of security. In particular, the central server is also designed to manage exchanges of exchangeable data between firstly the terminal 5, 8, and secondly the central server 2 or mobile terminals 5 belonging to other users of the communication set up service. The application program installed on each terminal is also designed to:
display the state of exchangeable data accounts managed by the central server 2 and/or service provider servers 3,
send exchange proposals as user profile data, in which the user specifies the type and quantity of proposed data and the type of the data required in exchange,
view, modify or delete exchange proposals that he has sent, as they are memorized in the database 4 and possibly by the terminal,
receive lists of exchange proposals sent by other service users, from the central server,
select an exchange proposal located in a list displayed by the terminal, particularly in order to get into communication with the user who sent the selected exchange proposal, and
validate a transaction agreed upon with another user, this operation having the effect of sending a validation message to the central server 2 containing information about the transaction, memorized by the terminal.

The server 2 communicates with several service provider servers 3, such as shops or partner operators, for example through the numeric data transmission network 10, service providers outputting exchangeable data to their customers.

When a user registers with the service, which may be done either at the initiative of the user of the service provider, the central server receives the access code(s) to the user's accounts at the service providers. In this way, the server 2 can query the servers 3 to determine if a given user has an account at the corresponding service provider, and if so the quantity of data memorized on this account.

Alternatively, the central server can manage accounts assigned by service providers, and in this case the central server will be designed to receive orders to update these accounts sent by service providers.

To access a user's accounts, the central server 2 searches for access information to user accounts memorized in the database 4, and uses this access information to query servers 3 that transmit quantities of data accumulated on the user's corresponding accounts in response.

To input an exchange proposal in his profile, the user inputs the types and quantities of data that he would like to exchange. The terminal transmits this information to the central server 2 in an update profile message. To define an exchange proposal, the user can use predefined conversion formulas, depending on the market value of each type of data. Once the exchange proposal is completed with the quantity of data of the required type, corresponding to the proposed data quantity, the server 2 inserts it into the users database 4.

Conversion formulas between data types may for example be defined by partner service providers. In one variant of the system according to the invention, they can also be chosen by users.

Before sending an exchange proposal to the central server, the terminal can check that the quantity of data proposed in the exchange proposal is less than or equal to the quantity appearing in the corresponding account, the terminal including means for asking the server 2 about the state of the corresponding accounts. This check may also be made directly by the central server from a received exchange proposal, by querying the corresponding account of the user who sends the exchange proposal. If the received exchange proposal is not valid because the proposed data quantity does not appear on the account of the user who made the proposal, this proposal is not recorded in the database 4 and therefore will not appear in the lists of exchange proposals sent to users. In this case, the central server could also send an error message to the person who sent the invalid proposal.

When two users who would like to exchange data are put into communication by the central server, they can discuss the terms of the exchange. When they agree on the types and quantities of exchanged data, they input this information into their terminal and activate a validation command provided for this purpose on their corresponding terminals. It would then be possible to display a download window on the terminal showing icons symbolizing the nature of exchanged data. In this way, users will know that at the end of downloading, they will be in possession of the data that they wanted to obtain through the exchange, but on the other hand they will no longer have the data that they offered in exchange.

Following activation of a validation command, the terminal sends a validation message to the central server 2 containing the accepted exchange proposal, this message is retransmitted to the terminal of the other user, which displays this information in the download window. Reception of this type of validation message triggers activation of the procedure 30 shown in FIG. 3.

In this Figure, the central server waits for step 31 for reception of a validation message from another user who is party to the exchange transaction. If the central server receives two validation messages concerning the same exchange and originating from two different users (step 32), the central server executes debit and credit orders for the corresponding accounts of the two users, possibly through servers 3 corresponding to the exchanged data types (step 33).

If a debit order cannot be executed because the quantity of data to be debited is greater than the quantity appearing on the user's account, the server 3 transmits an error message to the central server 2 in response, and the central server cancels the exchange and does not validate or does not request the data transfer to be made in counterpart for the exchange.

Depending on the result of execution of the exchange, the central server then sends an exchange execution report message (step 34) to the terminals of the two users who participate in the exchange, this message containing information indicating whether or not the exchange was made.

If the exchange transaction was executed by the central server, it also updates the database 4 by subtracting the exchange proposal that was thus executed.

If the execution report message received by each terminal indicates that the exchange could not be executed, the terminal displays an error message. In both cases, it updates the download window by deleting the icon representing the offered data from the display, and displaying the icon representing the data obtained in exchange if the exchange was completed, and conversely deletes the display of the icon representing data obtained in exchange and keeps the icon representing the offered data, if the exchange was completed.

These arrangements manage simultaneous exchanges on terminals of users who exchange data.

When a user retrieves data from a service provider 3 at which he is not a client following such an exchange, the central server 2 saves these data on a local account assigned to the user; and for example memorized in the database 4.

If the central server 2 can access geographic positioning functions to determine the position of users using a mobile terminal, the application program installed on each terminal is also capable of limiting exchange proposals transmitted in lists by the communication set up service, to proposals sent by nearby users. Similarly, the central server includes means for determining which users are located nearby a determined user, based on geographic positioning information about service users, and, if requested, means for building up and sending a list of exchange proposals sent by other users located nearby the user who sent the request. This list may also be limited to exchange proposals corresponding to the proposal made by the user who requests the list, in other words exchange proposals for which at least the types of data to be exchanged correspond.

If user terminals are equipped with low range communication means, and if users choose to be visible by inputting this choice in their terminal, the server 2 sends the list of exchange proposals memorized by all “visible” terminals located nearby. The application program installed in the terminal then displays the received list.

When a user selects an exchange proposal sent by another nearby user in the list displayed on his terminal, the terminal of the first user gets into direct communication with the terminal of the second user through low range communication means, using addressing information supplied by the central server. The exchange transaction takes place as described above, but without involving the central server. This is why security measures must be taken to prevent an unfair exchange taking place (exchanges from debit accounts).

Consequently, data to be exchanged appearing on the account of each of the two users must have been transferred into the terminal memory beforehand. The central server subtracts the quantity of data transferred between the central server 2 and the terminal from the corresponding account.

Moreover, exchangeable data transferred into the terminal memory are preferably recorded within a protected memory area, and are only accessible for update by the application program dedicated to the exchange installed on the terminal. For example, these data may be stored in encrypted form, and only the application program knows the decryption key.

It is also necessary for the user to connect to the server 2 sufficiently frequently so that accounts memorized in the terminal memory are synchronized with the real accounts managed by the server 2 or servers 3. At the time of each connection, the central server recognizes exchanges made locally and debits or credits the corresponding accounts as a function of received exchange information.

When the second user who sent the exchange proposal accepted by the first user accepts the exchange in turn, a validation message is sent by the second user's terminal to the first user's terminal which triggers downloading of the proposed data by the first user's terminal, and downloading of the corresponding exchanged data by the second user's terminal. When the two terminals have received an acknowledgement of reception message from the other terminal, the data quantity emitted by each of the two terminals is subtracted from the terminal memory.

When the terminal makes another connection to the central server, the user can trigger transfer of exchangeable data memorized by his terminal to corresponding accounts managed by the call server 2 or servers 3, this transfer obviously resulting in the subtraction of data transmitted from the terminal memory.

With the system described above, users can exchange data in the form of a barter in a completely transparent manner, in other words having the impression of manipulating the exchanged data but without having direct access to it during the exchange.

1. A System for setting up communications between users of a telecommunication network (1, 10), each user being provided with a terminal providing access to the telecommunication network,
wherein the system comprises a central server (2) designed to provide a service for setting up a communication, this server comprising:
means (4) for memorizing for each user a user identifier for the communication set up service, associated with information necessary to set up a communication with the user's terminal and profile information based on which the user would like to use his terminal to get into anonymous communication with other service users;
means for receiving profile information sent by users, and storing it in the memory means (4);
means for distributing the received profile information on user terminals (5, 8), and
means for receiving requests from user terminals for setting up a communication based on user profile information, and means for setting up a communication between two user terminals following reception of a communication set up request,
each user terminal comprising means for receiving and displaying user profile information sent by the central server, means for selecting the profile information of a user, and means for transmitting to the central server a request to set up a communication with the user corresponding to the selected profile information.

2. The system according to claim 1, wherein said user terminals (5) are fixed or mobile terminals.

3. The system according to claim 1, wherein the central server (2) comprises means for extracting from the memory means (4) a list of user profiles corresponding to a selection criterion sent by a user terminal, and means for transmitting the extracted list to the user terminal.

4. The system according to claim 1, wherein the central server (2) comprises means for determining the geographic position of users registered in the communication set up service, means for inserting in the memory means (4) the geographic position of each user in association with profile information, and means for extracting from the memory means (4) a list of user identifiers located close to a determined user, using memorized geographic positions.

5. The system according to claim 4, wherein at least some of the terminals (5, 8) of users of the communication set up service are of the mobile terminal type including low range communication means for communicating directly with other nearby user terminals without needing a telecommunication network, the central server comprising means for transmitting to a mobile terminal information necessary for setting up a direct communication with the terminal located nearby, following reception of a request sent by the terminal to set up a communication with the nearby terminal.

6. The system according to claim 1, wherein the central server (2) uses a WAP and/or Web service.

7. The system according to claim 1, wherein the user profile information contains exchange proposals, each exchange proposal including types and quantities of exchangeable data offered and requested in exchange, the central server also comprising means for receiving exchange validation messages sent by terminals of users who accepted an exchange proposal sent by a user, and means for retransmitting each received validation message to the terminal of the user who sent the corresponding exchange proposal, and means for updating exchangeable user data accounts whenever a proposal for an exchange is accepted, as a function of types and quantities of data to be exchanged specified by the accepted exchange proposal.

8. The system according to claim 7, wherein each user terminal (5, 8) in the exchange service includes means for transmitting a message to the central server (2) to request the quantity of data appearing on each account available to the user, and means for receiving and displaying the data type and quantity information received in response from the central server.

9. The system according to claim 7, wherein the central server (2) comprises means for canceling an exchange transaction validated when the exchanged data are not present on the corresponding accounts of users participating in the transaction.

10. A terminal (5, 8) used to equip users of a communication set up service, comprising:
connection means for connecting the terminal to a central server (2) through a telecommunication network (1, 10),
means for inputting and sending to the central server profile information including a user identifier,
means for receiving from the central server lists of profile information sent by other users of the communication set up service, and displaying these lists on the terminal, and means for selecting a displayed user profile, and
means for sending a request to set up a communication with the user corresponding to the user profile displayed by the terminal and selected using selection means.

11. The terminal according to claim 10, wherein the terminal is of the fixed (8) or mobile (5) terminal type.

12. The terminal according to either claim 10, wherein the terminal is of the mobile terminal type and includes low range communication means for communicating directly with other nearby user terminals, and means for receiving information necessary to set up a direct communication with the nearby terminal, when requested.

13. The terminal according to claim 10, further comprising:
means for inputting an exchange proposal including an identifier of the user who sent the exchange proposal, a type and a quantity of exchangeable data offered, and a type of data requested in exchange, and sending this proposal to the central server,
means for receiving lists of exchange proposals sent by the other users of the exchange service, the lists being transmitted through the central server, and means for selecting a displayed exchange proposal, and displaying these lists on the terminal, and
means for sending a validation order for an exchange proposal displayed by the terminal and selected using the validation means.

14. The terminal according to claim 10, further comprising means for displaying a download window in which icons are displayed symbolizing exchanged data, to give the user the impression of physically exchanging data.
